(19) United States
(12) Patent Application Publication
(10) Pub. No.: US 2003/0217925 A1
(43) Pub. Date: Nov. 27, 2003

(54) Electrophoresis gel identifier and method of making and using the same

(75) Inventors: William F. Alpenfels, Del Mar, CA (US); Anthony Paul DiScuillo, Oceanside, CA (US); Gary Lee Ousley, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: PageGel, Inc.

(21) Appl. No.: 10/414,940

(22) Filed: Apr. 15, 2003

Related U.S. Application Data
(60) Provisional application No. 60/374,055, filed on Apr. 19, 2002.

(51) Int. Cl. G01N 27/27; G01N 27/403

(52) U.S. Cl. 204/470; 204/469; 204/615

(57) ABSTRACT

A method of creating an electrophoresis gel having a gel electrophoresis identifier includes providing a surface including a gel electrophoresis identifier marker; providing an electrophoresis gel on the surface having the gel electrophoresis identifier marker; and forming a gel electrophoresis identifier on the electrophoresis gel with the gel electrophoresis identifier marker of the surface. The gel electrophoresis identifier is used to identify and orient the gel.

### CROSS REFERENCE TO RELATED APPLICATIONS

This application claims the benefit of U.S. Provisional Application No. 60/374,055 filed on Apr. 19, 2002 under 35 U.S.C. 119(e).

### FIELD OF THE INVENTION

The invention relates to electrophoresis gel identifiers.

### BACKGROUND OF THE INVENTION

Gel electrophoresis is a common procedure for the separation of biological molecules, such as DNA, RNA, and proteins. In gel electrophoresis, the molecules are separated into bands according to the rate at which an imposed electric field causes them to migrate through a filtering gel.

The basic apparatus used in this technique consists of a gel enclosed in a glass tube or sandwiched as a slab between glass or plastic plates. The gel has an open molecular network structure, defining pores which are saturated with an electrically conductive buffered solution of a salt. These pores through the gel are large enough to admit passage of the migrating molecules.

The gel is placed in contact with buffer solutions which make electrical contact between the gel and the cathode or anode of an electrical power supply. A sample containing the macromolecules and a tracking dye is placed on top of the gel. An electric potential is applied to the gel causing the sample macromolecules and tracking dye to migrate toward the bottom of the gel. The locations of the bands of separated macromolecules are then determined. By comparing the distance moved by particular bands in comparison to the tracking dye and macromolecules of known mobility, the mobility of sample macromolecules can be determined. Once the mobility of the sample macromolecules is determined, the size of the macromolecule can be calculated.

Electrophoresis gels are commonly identified by marking the external surface of the plates or carrier with a permanent marker, printed labels, or the like. A problem with this approach is that the identification information is lost if the gel is removed from the plates or carrier for post-separation processing (e.g., staining, transfer).

When running several gels at one time, it is important to know which gel contains which samples. Further, it is important when running a gel to know which lane contains which sample. Because gels often have symmetrical sample lanes, distinguishing the left side from the right side is imperative for determining where the samples are located.

In order to distinguish one gel from another as well as the left side and right side of the gel, a common practice is to load special samples in a particular pattern that uniquely identifies each gel run as well as the gel's orientation. This special pattern loading technique complicates the electrophoresis process and may consume extra sample wells when large numbers of gels are run at once. Alternatively, corners of the gels may be cut off when removing the gels from the carriers to distinguish one gel from another. This technique may work for marking the proper orientation of a small number of gels at one time, but is not practical for marking the proper orientation of a large number of gels. Another method of identifying gels is to mark, for example, by imprinting, the containers in which the respective gels are processed. This can be problematic since the user must take great care not to mix up the gels once they are dissociated with their respective containers, which could place the validity of the gel run in question.

Therefore, a need exists to solve both the gel orientation and identification problems described above so that the user is free to load samples in the most convenient manner, without having to additionally mark or label the carrier.

### SUMMARY OF THE INVENTION

An aspect of the invention involves a method of making an electrophoresis gel having a gel electrophoresis identifier includes providing a surface having a gel electrophoresis identifier marker; providing an electrophoresis gel on the surface including the gel electrophoresis identifier marker; and forming a gel electrophoresis identifier on the electrophoresis gel with the gel electrophoresis identifier marker of the surface. The gel electrophoresis identifier is used to identify and orient the gel.

Another aspect of the invention involves an electrophoresis carrier including a transparent front carrier member including an inner side, a transparent rear carrier member including an inner side, and an electrophoresis gel sandwiched between the inner sides of the transparent front carrier member and the transparent rear carrier member. At least one of the inner sides of the transparent front carrier member and the transparent rear carrier member including a gel electrophoresis identifier marker that contacts the electrophoresis gel to form a gel electrophoresis identifier on the electrophoresis gel to identify and orient the gel.

A further aspect of the invention involves a method of identifying and orienting an electrophoresis gel including providing an electrophoresis gel including an embossed electrophoresis gel identifier, and using the embossed electrophoresis gel identifier to identify and orient the gel.

Further objects and advantages will be apparent to those skilled in the art after a review of the drawings and the detailed description of the preferred embodiments set forth below.

### BRIEF DESCRIPTION OF THE DRAWINGS

FIG. 1 is a perspective view of a thin, plastic-film gel electrophoresis assembly including an embodiment of an electrophoresis gel identifier marker.

FIG. 2 is a top plan view of a support frame of the thin, plastic-film gel electrophoresis assembly illustrated in FIG. 1.

FIG. 3 is a top plan view of a first, inner thin-film member including an embodiment of the electrophoresis gel identifier marker.

FIG. 4 is a top plan view of a second, outer thin-film member.

### DETAILED DESCRIPTION OF PREFERRED EMBODIMENTS

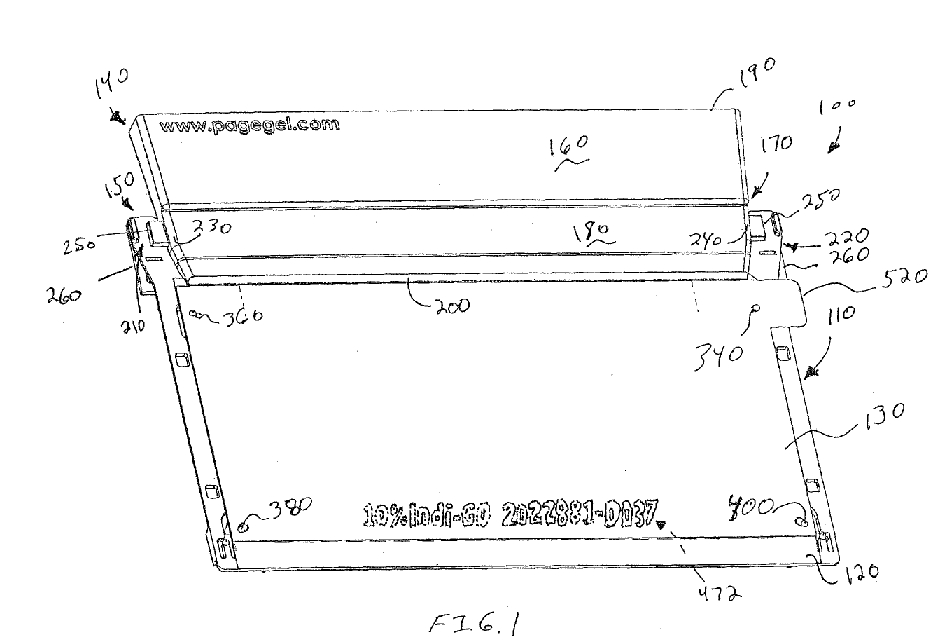

With reference to FIG. 1, a thin, plastic-film gel electrophoresis assembly 100 will first be generally described, followed by a description of an embodiment of an electrophoresis gel identifier marker.

The assembly 100 includes a support frame 110 that carries a gel sandwiched between a first, rear, inner thin-film member 120 and a second, front, outer thin-film member 130. A reservoir 140 is detachably mounted to a top 150 of the support frame 110.

The reservoir 140 includes an upper portion 160, and intermediate portion 170, and a lower portion 180 that gradually tapers in thickness from a wide, open top 190, where samples are introduced, to a narrow, open bottom 200, where the samples electrophoretically migrate from a first gel in the reservoir 140 to a second gel sandwiched between the thin-film members 120, 130. The upper portion 160 has a trough-like configuration. The lower portion 180 may include a plurality of divided wells. Mounting mechanisms 210, 220 extend from opposite ends 230, 240 of the reservoir 140. Each mounting mechanism 210, 220 includes a first, small, front laterally protruding member 250 and a parallel second, large, rear laterally protruding member 260.

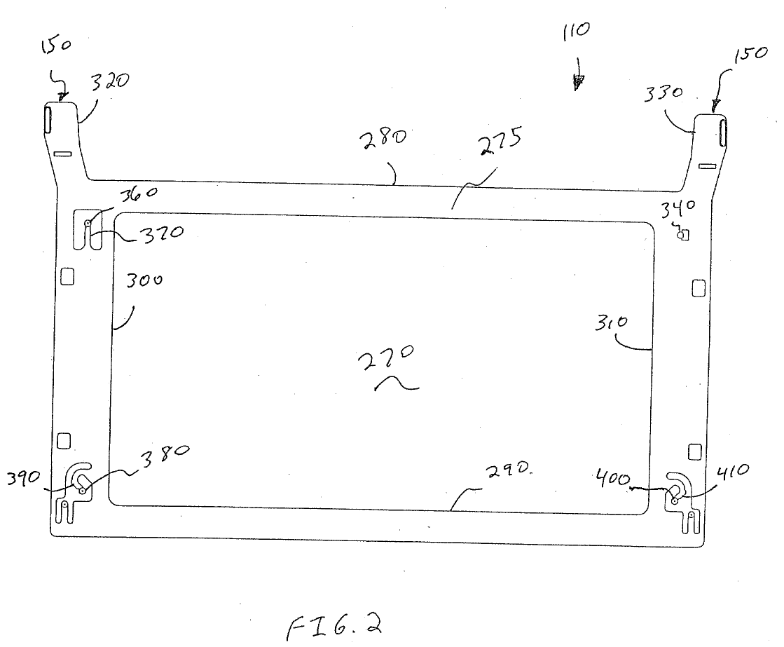

With reference additionally to FIG. 2, the support frame 110 will now be described in more detail. The support frame 110 is made of a flexible, resilient plastic material and has a substantially rectangular configuration with a central rectangular hole 270 and a substantially flat face 275. The support frame 110 includes an upper lateral support 280, a lower lateral support 290, a left vertical support 300, and a right vertical support 310. The vertical supports 300, 310 terminate at their tops 150 in ear-like protrusions 320, 330. The ear-like protrusions 320, 330 are slidably received between the front and rear protruding members 250, 260 of the mounting mechanisms 210, 220 for detachably mounting the reservoir 140 to the support frame 110.

A fixed support post 340 extends outwardly from the right vertical support 310 near an upper-right corner of the support frame 110. The support post 340 includes an undercut on a right portion of the support post 340.

A support post 360 extends outwardly from the left vertical support 300 near an upper-left corner of the support frame 110. The support post 360 is connected to the left vertical support 300 via a flexible, resilient, straight connection member 370. Similar to a spring, the connection member 370 provides a biasing force in a direction opposite to that in which it is displaced. The connection member 370 may be moved laterally, forward, and rearward. The support post 360 includes an undercut that extends around the entire circumference of the support post 360, except where the support post 360 is attached to the connection member 370.

A support post 380 extends outwardly from the left vertical support 300 near a lower-left corner of the support frame 110. The support post 380 is connected to the left vertical support 300 via a flexible, resilient, curved, hook-shaped connection member 390. Similar to a spring, the connection member 390 provides a biasing force in a direction opposite to that in which it is displaced. The connection member 390 may be moved up and to the right, down and to the left, forward, and rearward. Because the connection member 390 is curved, if the connection member 390 is displaced, for example, upward and toward the right, the connection member 390 will provide a biasing force in an opposite direction, namely, downward and toward the left. The support post 380 includes an undercut that extends around a lower-left portion of the circumference of the support post 380.

A support post 400 extends outwardly from the right vertical support 310 near a lower-right corner of the support frame 110. The support post 400 is connected to the right vertical support 310 via a flexible, resilient, curved, hook-shaped connection member 410, similar to the connection member 390. If the connection member 410 is displaced, for example, upward and toward the left, the connection member 410 will provide a biasing force in an opposite direction, namely, downward and toward the right. The connection member 410 may be moved up and to the left, down and to the right, forward, and rearward. The support post 400 includes an undercut similar to the undercut that extends around a lower-right portion of the circumference of the support post 380.

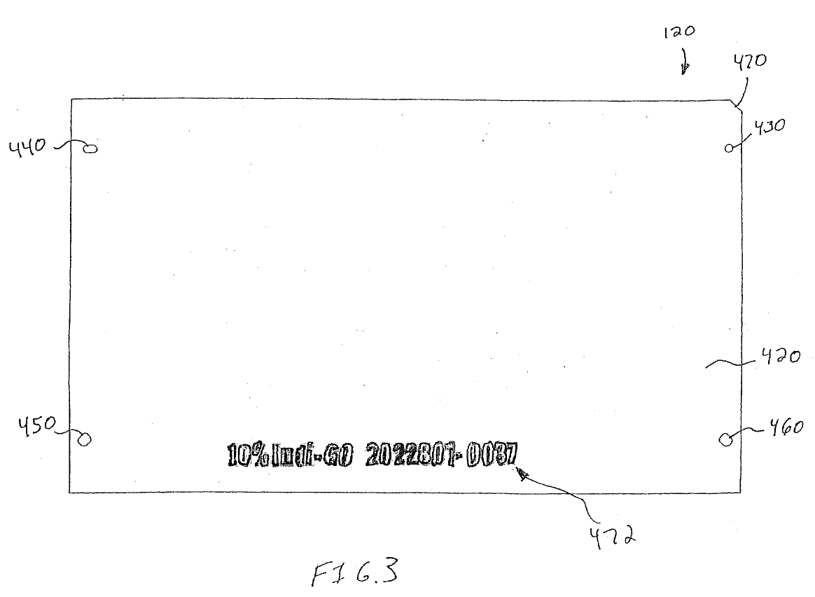

With reference to FIGS. 1 and 3, the inner thin-film member 120 and an embodiment of the electrophoresis gel identifier marker will now be described. The inner thin-film member 120 is preferably a thin, rectangular piece of plastic, transparent film such as cellophane film and may include the second gel disposed on a front side or inner side 420. The inner thin-film member 120 includes four holes 430, 440, 450, 460 that receive the four support posts 340, 360, 380, 400 in a manner to be described. A small, upper-right hole 430 is circular. An upper-left hole 440 is laterally elongated to allow for lateral movement of the upper-left support post 360 therein. A lower-left hole 450 has a round, diamond shape and is larger than the upper-right hole 430. A lower-right hole 460 is similar in shape and size to the lower-left hole 450. A clipped corner 470 of the inner thin-film member 120 may help in orienting the inner thin-film member 120 when mounting it to the support frame 110.

The inner side 420 may include a permanent electrophoresis gel identifier marker 472 in a lower portion and on the inner side 420 of the inner thin-film member 120. The identifier marker 472 may be an engraving, scribing or etching on the inner side 420 of the inner thin-film member 120. The identifier marker 472 may include one or more of a name, a serial number, an alphanumeric identifier, or other indicia for creating a like identifier on the gel for identifying the gel and the samples run in the gel. When the electrophoresis gel is cast or otherwise added to the inner side 420 of the inner thin-film member 120, the resulting gel fills in and around the identifier marker 472, creating a corresponding permanent embossed identifier on the surface of the gel.

The permanent electrophoresis gel identifier marker 472 may be created on the inner side 420 of the inner thin-film member 120 using a CO₂ laser scribe. An exemplary laser scribe that may be used is the Model DGM-1 Laser Scribe from the Domino company of Anaheim, Calif. The CO₂ laser was set to a 15% power level for use on 100 micrometer (0.1 mm) thick polyester films such as the Gel-Fix for Agarose or the Gel-Fix for PAG film sold by Serva Electrophoresis GmbH of Heidelberg, Germany. Other scribing instruments may be used to create the identifier marker 472 on the inner side 420 of the thin-film plastic member 120 such as, but not by way of limitation, a scratch awl, a diamond pen, and an electric scribe. In the embodiment of the electrophoresis gel identifier marker 472 shown, a phrase and serial number are scribed onto the inner side 420 of the inner thin-film member 120 to make a corresponding unique embossed identifier on the resulting electrophoresis gel cast onto the inner side 420. Exemplary electrophoresis gels include agarose, polymerizing cross-linked Acrylamide using either usual chemical or photo initiators, combinations of agarose and acrylamide, or other appropriate matrixes that change from a fluid consistency to a gel.

Although the electrophoresis gel identifier marker 472 has been described as being located on an inner side 420 and in a lower portion of the inner thin-film member 120, the identifier marker 472 may be located at one or more additional or alternative locations to the lower portion on the inner side 420 of the inner thin-film member 120 such as, but not by way of limitation, near a right edge and/or left edge of the inner thin-film member 120. The electrophoresis gel identifier marker 472 is preferably located in an area where sample may not be present because the identifier marker 472 may change the thickness or chemical properties of the mold sufficient to distort the resulting electrophoresis separation of samples run over the identifier marker 472.

Although the identifier marker 472 has been described as being located on an inner side of thin-film plastic member 120, the identifier marker 472 may be located on the inner surface of any gel carrier or casting apparatus (e.g., glass plates, plastic plates).

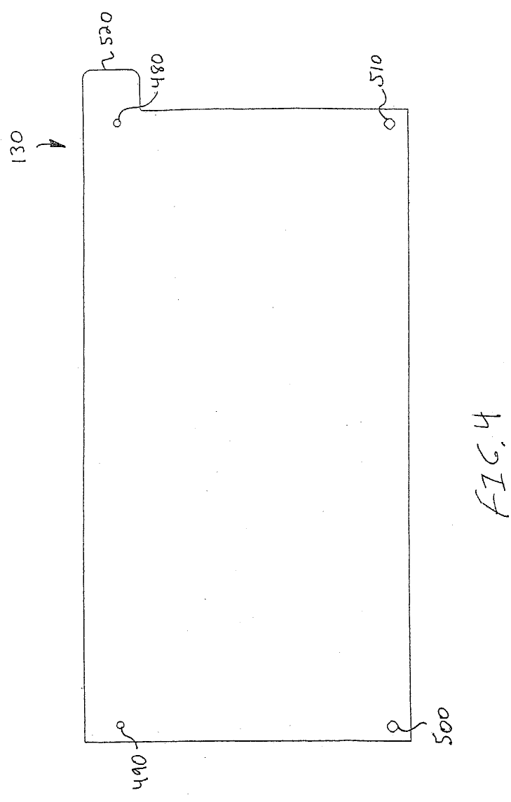

With reference to FIG. 4, the outer thin-film member 130 will now be described. The outer thin-film member 130 is preferably a thin, substantially rectangular piece of plastic, transparent film such as cellophane film. The outer thin-film member 130 includes four holes 480, 490, 500, 510 that receive the four support posts 340, 360, 380, 400 in a manner to be described. A small, upper-right hole 480 and upper-left hole 490 are circular. A lower-left hole 500 and a lower-right hole 510 have round, diamond shapes and are larger than the upper holes 480, 490. The left holes 490, 500 are closer to the right holes 480, 510 than the corresponding holes in the outer thin-film member 130. A tabbed corner 520 of the outer thin-film member 130 may be used to handle the outer thin-film member 130 and may help orient the outer thin-film member 130 when mounting it to the support frame 110. Similar to the inner thin-film member 120, the outer thin-film member 130 may include an inner side with an electrophoresis gel identifier marker 472.

During assembly of the gel, the gel is cast on the inner thin-film member 130. The resulting gel fills in and around the laser-scribed electrophoresis gel identifier marker 472, causing a corresponding embossed identifier to be formed on the back surface of the gel, which abuts the inner side 420 of the inner thin-film member 130. Because the gel and thin-film members 120, 130 are transparent, the identifier on the back surface of the gel is visible when looking at the gel and film members 120, 130 from a front perspective. The identifier on the gel serves as a permanent descriptive label on the gel that may be used to uniquely identify the gel and the samples run on the gel after separation. Although the identifier has been described as being located on the surface of the gel, in an alternative embodiment, the identifier may be located within the gel. Locating the identifier on the gel overcomes the problems in the past with identifying electrophoresis gels by marking the external surface of the plates or carrier. The identifier on the gel helps the user in orienting the gel because when the identifier can be read in a normal left-to-right fashion the user knows the gel is properly oriented. This eliminates the orientation problems with gels and carriers in the past.

It will be readily apparent to those skilled in the art that still further changes and modifications in the actual concepts described herein can readily be made without departing from the spirit and scope of the invention as defined by the following claims.

What is claimed is:

1. A method of making an electrophoresis gel having a gel electrophoresis identifier, comprising:
providing a surface including a gel electrophoresis identifier marker;
providing an electrophoresis gel on the surface having the gel electrophoresis identifier marker;
forming a gel electrophoresis identifier on the electrophoresis gel with the gel electrophoresis identifier marker of the surface, the gel electrophoresis identifier used to identify and orient the gel.

2. The method of claim 1, wherein the surface is an inner side of a carrier.

3. The method of claim 2, wherein the surface is an inner side of a thin-plastic film.

4. The method of claim 2, wherein the surface is an inner side of a plastic plate.

5. The method of claim 2, wherein the surface is an inner side of a glass plate.

6. The method of claim 2, wherein the carrier includes a front member and a rear member, and the surface is at least one of an inner side of the front member and an inner side of the rear member.

7. The method of claim 1, wherein the surface includes a bottom edge, a left edge and a right edge, and the gel electrophoresis identifier marker is located at one or more locations from the group consisting of near the bottom edge, near the left edge, and near the right edge.

8. The method of claim 1, wherein the gel electrophoresis identifier marker is a member from the group consisting of an engraving, a scribing, and an etching.

9. The method of claim 1, further including laser etching the gel electrophoresis identifier marker into the surface.

10. The method of claim 1, further including creating the gel electrophoresis identifier marker using an instrument from the group consisting of a scratch awl, a diamond pen, and an electric scribe.

11. An electrophoresis carrier, comprising:
a transparent front carrier member including an inner side;
a transparent rear carrier member including an inner side;
an electrophoresis gel sandwiched between the inner sides of the transparent front carrier member and the transparent rear carrier member,
wherein at least one of the inner sides of the transparent front carrier member and the transparent rear carrier member including a gel electrophoresis identifier marker that contacts the electrophoresis gel to form a gel electrophoresis identifier on the electrophoresis gel to identify and orient the gel.

12. The electrophoresis carrier of claim 11, wherein the transparent carrier members are thin-plastic film members.

13. The electrophoresis carrier of claim 11, wherein the transparent carrier members are plastic plates.

14. The electrophoresis carrier of claim 11, wherein the transparent carrier members are glass plates.

15. The electrophoresis carrier of claim 11, wherein the inner sides include a bottom edge, a left edge and a right edge, and the gel electrophoresis identifier marker is located at one or more locations from the group consisting of near the bottom edge, near the left edge, and near the right edge.

16. The electrophoresis carrier of claim 11, wherein the gel electrophoresis identifier marker is a member from the group consisting of an engraving, a scribing, and an etching.

17. The electrophoresis carrier of claim 16, wherein the gel electrophoresis identifier marker is a laser etching.

18. A method of identifying and orienting an electrophoresis gel, comprising:
providing an electrophoresis gel including an embossed electrophoresis gel identifier, and
using the embossed electrophoresis gel identifier to identify and orient the gel.
